(19) United States
(12) Patent Application Publication
(10) Pub. No.: US 2003/0233919 A1
(43) Pub. Date: Dec. 25, 2003

(54) Pneumatic cathode ray tube cutting system

(76) Inventors: Greg Yourkievitz, Oldsmor, FL (US); Curtis Yourkievitz, St. Petersburg, FL (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 10/175,698

(22) Filed: Jun. 20, 2002

(51) Int. Cl. B26D 1/00

(52) U.S. Cl. 83/35

(57) ABSTRACT

An apparatus for bisecting a CRT is disclosed. The device separates the funnel portion of the CRT, which is composed of a leaded glass, and panel portion of the CRT, which is composed of an unleaded glass, for recycling purposes. The apparatus consists of a lateral track along which the CRT moves. Opposing sides of the CRT are cut by circular saws disposed on opposite sides of the track. The CRT is then rotated 90 degrees and a second set of saws cuts the remaining opposing sides of the CRT.

### GOVERNMENT INTEREST

This invention was developed under a contract with the Department of Defense, United States Federal Government Contract No. 00372.228.ED.10D.GLS. As a result, the U.S. Government may have certain rights in this invention.

### FIELD OF THE INVENTION

This invention pertains to the field of recycling and, in particular, to the recycling of glass of the type commonly found in cathode ray tubes, of which a portion is an unleaded glass and a portion is a leaded glass. The invention describes an apparatus for separating the leaded glass from the unleaded glass of the cathode ray tubes.

### BACKGROUND OF THE INVENTION

This invention is directed to the recycling of used cathode ray tubes (CRTs), which are used mainly in computer monitors and television sets. The typical cathode ray tube is constructed of two glass portions. The first portion is the funnel portion, which is composed of leaded glass which is approximately 21-25% by weight lead oxide. The lead oxide in the glass is used for containing the radiation produced by the electron gun of the CRT, which is positioned at the small, rear end of the funnel portion and which shoots electrons from the rear of the funnel to the front of the panel, where they impact, activating phosphors on the front panel of the CRT to create the image. The front panel, or display area of the CRT, is typically manufactured with an unleaded glass. During the manufacturing process the panel portion and the funnel portion are fused together to form the body of the CRT. The electron gun is then affixed to the rear of the funnel and a vacuum is drawn in the CRT by expelling the air. The panel portion and the funnel portion of the CRT are typically fused or fluxed together with a lead oxide frit, using heat. The lead frit is composed of approximately 75-80% lead oxide. The joint between the panel and the funnel of the CRT is referred to as the frit line.

Due to the lead content in the CRT and the frit, some states have enacted or are considering enacting land fill ban laws, which would ban the disposal of CRTs in the land fills. Therefore, there is a need to provide an alternate disposal method for CRT glass and, in particular, the funnel and frit line portions of the CRT, which contain the lead oxide. To avoid the disposal of the CRTs in land fills, it is desirable to be able to recycle the glass into new CRTs. However, to recycle the glass it is necessary to separate the portion of the CRT containing the lead (i.e. the funnel and frit joint) from the portion of the CRT containing no lead or low lead glass (i.e. the panel). After the glass types are separated, they can be further processed to produce furnace ready cullet, which can be recycled. The recycled glass (i.e. the cullet) is typically used to manufacture new CRT screens. While the leaded glass is able to tolerate some contamination with the low lead or unleaded glass from the panel portion of the CRT, there is near-zero tolerance for contamination of the panel glass with leaded glass from the frit or funnel portion of the CRT. Therefore, it is necessary to separate the two portions of the CRT.

Due to the lead oxide content of the CRT and the glass itself, separation of the two portion of the CRT can be hazardous. Typical risk factors include sharp saw blades, jagged glass edges, phosphor dust, lead dust and high voltage. Therefore, it would be desirable to have a way of separating the two portions of the CRT that lessens the degree of risk of exposure to both the operator and the environment. Secondly, because of the low tolerance for contamination of the unleaded glass panel portion with the leaded glass from the funnel portions, it is desirable that no funnel glass or leaded frit remain with the panel glass after the separation of the two parts of the CRT. Lastly, it is desirable that the separation of the two portions of the CRT be accomplished in a reasonable time cycle to make the recycling of the glass economical.

### SUMMARY OF THE INVENTION

The invention disclosed herein is a cutting apparatus which is able to separate the panel portion and the funnel portions of the CRT using a plurality of saws, which cut the CRT at a point on the panel side of the frit line. As stated previously, it is desired that the frit line remain with the funnel portion of the CRT because of its high lead content. The apparatus utilizes a plurality of small circular saw blades to cut the four sides of a typical CRT screen. The device is adjustable to accommodate varying sizes of CRT screens and in the primary embodiment, shown in FIG. 1, utilizes four circular saw blades, one of which cuts each sides of the CRT. In an alternative embodiment, eight circular saw blades are used, each of which cuts half of the thickness of the glass from one side of the CRT, to avoid overheating of the saw blade as the glass is cut, and to increase the cutting speed. The apparatus is enclosed in a housing to lessen the risk from contamination., and the process of positioning the CRT with respect to the saw blades is semi-automatic.

### BRIEF DESCRIPTION OF THE DRAWINGS

FIG. 1 shows a top plan view of a first embodiment of the invention utilizing four circular saw blades.

FIG. 2 is an elevational view of the embodiment of FIG. 1.

FIG. 3 is a second embodiment of the invention utilizing eight circular saw blades.

### DETAILED DESCRIPTION OF THE INVENTION

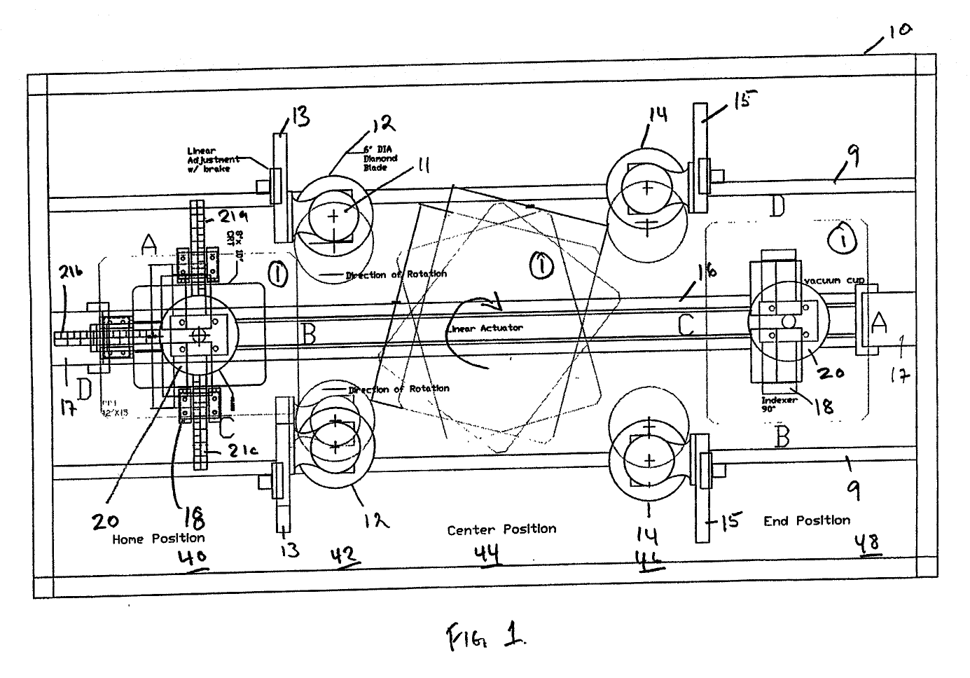

The preferred embodiment of the invention is best described with reference to FIG. 1, which shows the device in a top plan view. CRT 1 is mounted using vacuum cup 20 on actuator 18, which is moveable along track 16 through longitudinal axis of the apparatus. Actuator 18, with CRT 1 mounted thereon starts in home position 40 and passes from the left of FIG. 1 towards the right of FIG. 1 along track 16, coming to rest in end position 48. At position 42, CRT 1 encounters circular saw blades 12, driven by drivers 11. Circular saw blades 12 are adjustable along rails 13, supported by motor supports 8 to facilitate the accommodation of CRTs of various sizes. Blades 12 are preferably 6″ diameter diamond saw blades capable of cutting through the glass of CRT 1, which is typically approximately ⅜″ thick. As CRT 1 moves from position 40 through position 42, blades 12 come in contact with opposing sides A and C of CRT 1 and these sides are cut. After passing through saw blades 12 at position 42, CRT 1 enters center position 44, where it is rotated 90° by a rotary device on actuator 18. As actuator 18 moves CRT 1 through position 46, CRT 1 encounters saw blades 14, which are positioned along rails 15 to cut the remaining sides B and D of CRT 1. Note that both blade sets 12 and 14 are adjustable along rails 13 and 15 respectively to accommodate varying sizes of CRTs. After passing through position 46, all four sides of CRT 1 are now cut, and funnel portion of CRT 1 can now be removed from the panel portion at end position 48. The vacuum is then released from vacuum cup 20, allowing the panel portion to be removed and placed separately from the funnel portion.

To enhance the safety of the operation and, in particular, of the operator, the apparatus is enclosed in housing 10, which is a sealed cabinet which will capture glass fragments and phosphor particles which are present in the CRT and which may be liberated during the cutting process. In addition, any lead oxide dust generated by the cutting of the CRT is contained by the saw blade coolant and confined to cabinet 10.

As each of the saws contacts the CRT to make the cut, the blades 12 and 14 are sprayed with a water-based coolant or cutting fluid, via a set of nozzles mounted in close proximity to the blades (not shown). The nozzles and cutting fluids are commercial, off the shelf components, well known in the prior art. The cutting fluid serves to dissipate the friction of the heat generated by the cutting of the glass with the diamond blades to avoid the warping of blades 12 and 14 during the cutting process and to contain dust particles.

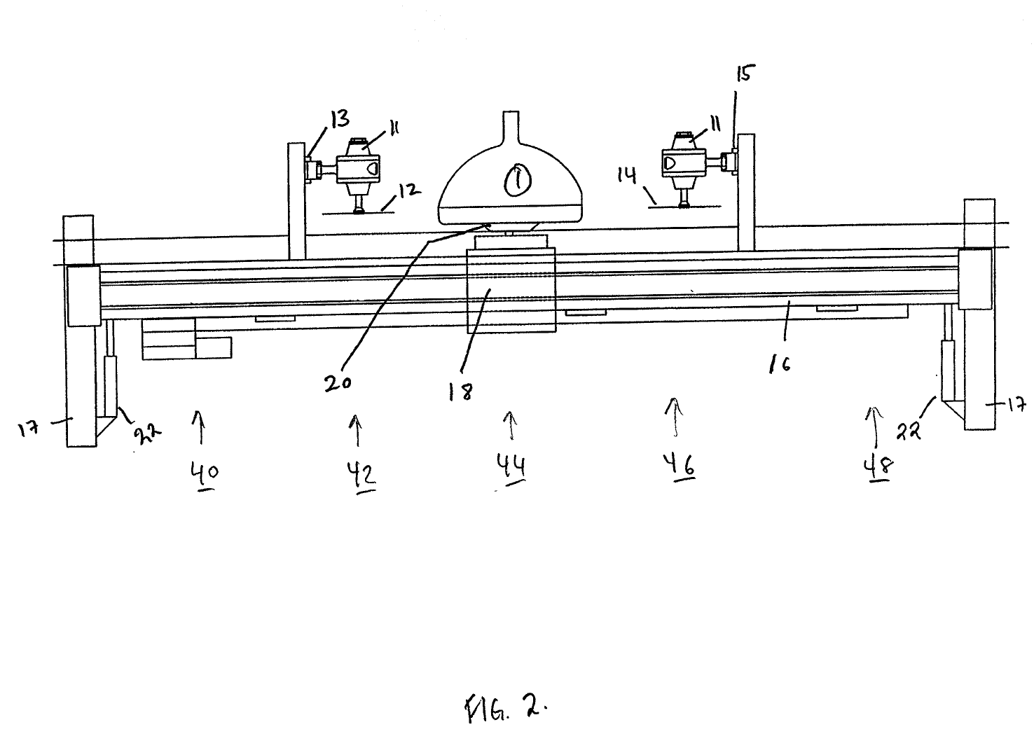

In the primary embodiment, shown in FIGS. 1 and 2, motors 11 are preferably air-powered. Blades 12 and 14 are preferably 4″-7″ masonry, lapidary or stainless saw blades which are rotated by motors 11 at approximately 1200 RPM. Although air motors are preferred, motors of any type capable of rotating the blades at the appropriate speed can be used.

In operation, the operator opens a door in cabinet 10 located near the home position 42, and positions the CRT 1 panel side down on vacuum cup 20. Preferably vacuum cup 20 is positioned in the center of the panel portion of CRT 1. A plurality of positioning stops, shown in FIG. 1 as 21a, 21b and 21c are locked in place and contact CRT 1 to aid the operator in positioning CRT 1 squarely on vacuum cup 20. Position stops 21a, 21b and 21c are adjustable depending on the size of the CRT.

Next, the operator must vertically position CRT 1 such that the blades contact CRT 1 at the appropriate level. In the preferred embodiment, the CRT is positioned such that the saws will contact the CRT approximately ¼″ below the frit line. One or more detector are used to assist the operator in the leveling of the CRT. In the preferred embodiment, the detector are laser pointers of the type commonly known in the art. The laser pointers are energized and CRT 1 is positioned such that the laser illuminates the point of contact with the blades on CRT 1. The position of CRT 1 can be adjusted vertically by adjusting the height of track 16, using adjustment members 22 shown in FIG. 2.

After CRT 1 is properly positioned, the operator activates a manual valve which allows air to power the vacuum generator for vacuum cup 20, which captures CRT 1 in position. The doors are then closed on cabinet 10, and the system is started. Preferably, safety interlocks will be present on all doors of housing 10 to prevent the apparatus from being operated while the doors are in the open position.

When actuator 18 is at home position 40, the first two motors 11 will be started, rotating saw blades 12. Saw blades on opposing sides of CRT 1 preferably rotate in opposite directions. Actuator 18 moves CRT 1 through position 42 and opposing sides A and C of CRT 1 contact saw blades 12. After opposing sides A and C of CRT 1 have been cut by blades 12, actuator 18 reaches center position 44 and CRT 1 is rotated 90° to facilitate the cutting of the uncut sides B and D. As CRT 1 is being rotated, saw blades 12 are powered down, and the second set of saw blades 14 are powered up. Actuator 18 then moves CRT 1 through position 46 where the uncut sides B and D of CRT 1 are cut by saw blades 14. When complete, actuator 18 moves to end position 48 and the saw blades 14 are powered down, whereupon the operator opens a second door in housing 10 near end position 48 and removes the separated pieces of CRT 1. The operator then closes the door and resets the apparatus, which will move actuator 18 back to home position 40, whereupon the apparatus is ready to repeat the process.

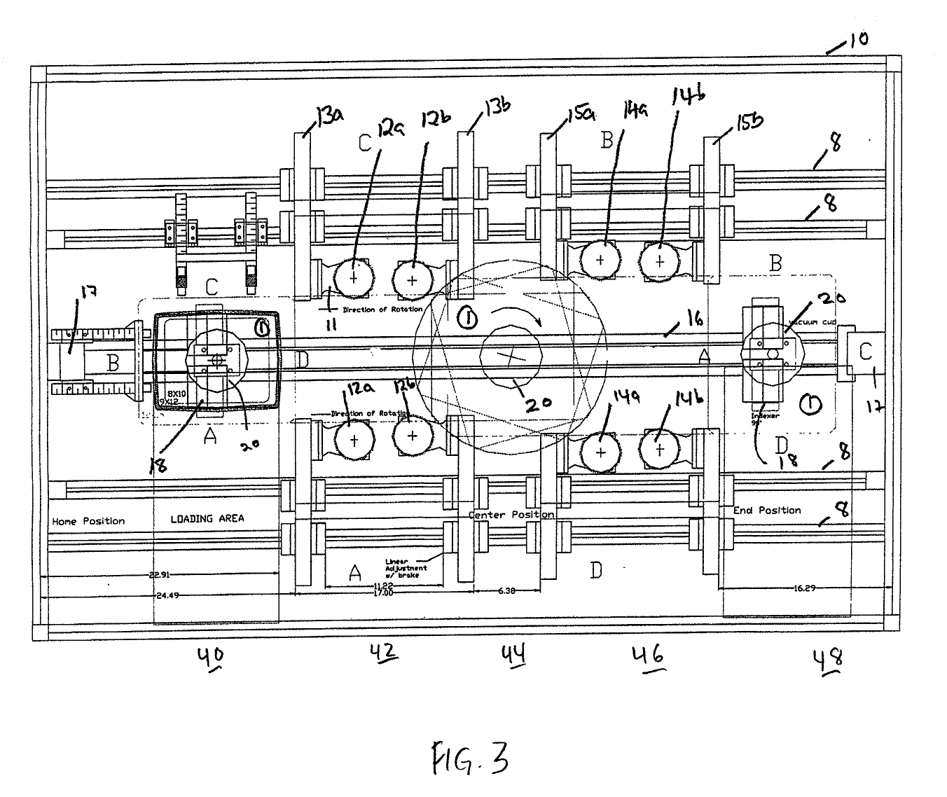

A second embodiment of the invention is shown in FIG. 3. In this embodiment, the four blades have been replaced by eight blades. In this version, the blades are preferably 4″ lapidary blades and may be rotated at a speed of up to approximately 3000 RPM. To cut sides A and C of CRT 1, blades 12a and 12b are used. Each set of blades 12a and 12b are positioned to cut approximately ½ the thickness of the glass wall of CRT 1. Because the glass of CRT 1 is approximately ⅜ of an inch thick at the cutting point, blades 12a will be positioned to cut the first 5/16″ of glass, while blades 12b will be positioned inwardly by approximately 5/16 of an inch and will cut the remainder of the thickness of the glass wall of CRT 1. While the glass itself is only ⅜″ thick, it is necessary to cut ⅝ of an inch total in order to produce a complete separation at the corners of the CRT 1, because of the curvature of the outer perimeter of the panel. When CRT 1 is moved to position 46 to cut sides B and D, blade sets 14a and 14b perform as do 12a and 12b; that is, blades 14a cut the first 5/16″ of the thickness of the glass while blades 14b are positioned inwardly to cut the second 5/16″ of the thickness of the glass and the corners. To support the additional weight of the motors 11 in the second embodiment, additional motor supports 8 have been added.

The modifications in the second embodiment result in less wear and tear on the blades and produce less heat during the cutting operation. As a result, the blades can be rotated at a higher RPM, preferably about 3000 RPM, and the cutting operation cycle can be completed faster than with the primary embodiment.

The apparatus disclosed herein has been described with reference to specific sizes and operating parameters which are exemplary only and should not be taken as a limitation to the invention, the scope of which is defined by the claims which follow.

We claim:

1. An apparatus for bisecting a CRT having a panel portion, a funnel portion and a frit line connecting said panel and funnel portions, comprising:
one or more saw blades; and
an actuator, for moving said CRT with respect to said one or more saw blades;
wherein said CRT is cut by said one or more saw blades around a circumference of said panel portion parallel to said frit line.

2. The apparatus of claim 1 further comprising a track, along which said actuator can be moved.

3. The apparatus of claim 2 wherein said actuator further comprises:
a vacuum cup for holding said CRT by creating a vacuum between said vacuum cup and said panel portion of said CRT; and
one or more stops for positioning said CRT with respect to said vacuum cup;
wherein said actuator can rotate said CRT at least 90 degrees in a horizontal plane parallel with said frit line.

4. The apparatus of claim 3 wherein said track and said actuator can be vertically adjusted with respect to said one or more saw blades.

5. The apparatus of claim 4 wherein said one or more saw blades comprise:
a first set of two saw blades, arranged with one blade on each side of said track; and
a second set of two saw blades, arranged with one blade on each side of said track;
said second set of blades being laterally displaced from said first set of blades along said track.

6. The apparatus of claim 5 wherein said first set of two saw blades cuts opposing sides of said CRT and said second set of saw blades cuts the remaining uncut opposing sides of said CRT.

7. The apparatus of claim 6 wherein said CRT is rotated ninety degrees between said first and said second set of blades.

8. The apparatus of claim 1 further comprising a housing for containing said apparatus, said housing having one or more doors therein to facilitate the placement and removal of said CRT.

9. The apparatus of claim 1 wherein said one or more saw blades are circular saw blades.

10. The apparatus of claim 9 wherein said one or more saw circular blades are rotated by one or more corresponding motors.

11. The apparatus of claim 10 where in said one or more motors are air-powered motors.

12. The apparatus of claim 9 wherein said one or more saw blades are of a type selected from a group comprising masonry, lapidary and stainless blades.

13. The apparatus of claim 1 further comprising one or more nozzles, disposed in close proximity to corresponding ones of said one or more saw blades, for spraying a cutting fluid on said blades during said bisecting process.

14. The apparatus of claim 1 further comprising one or more alignment members for adjusting the vertical position of said actuator.

15. The apparatus of claim 14 wherein said one or more alignment members are laser pointers which illuminate the position where said one or more blades will contact said CRT.

16. The apparatus of claim 4 further comprising:
a first set of four saw blades, arranged with two blades on each side of said track; and
a second set of four saw blades, arranged with two blades on each side of said track;
said second set of blades being laterally displaced from said first set of blades along said track;
wherein two blades of each of said first and second sets of blades are offset from the other two blades of each of said first and second sets of blades such that each of said blades cuts approximately one half of the depth of said glass of said CRT.

17. The apparatus of claim 16 wherein opposing sides of said CRT are cut simultaneously by said first set of four saw blades and the uncut opposing sides of said CRT are cut simultaneously by said second set of four saw blades.

18. An apparatus for bisecting a CRT having a panel portion, a funnel portion and a frit line connecting said panel and funnel portions, comprising:
a track;
an actuator, for holding said CRT during said bisecting process; said actuator being capable of moving along said track;
a first set of two saw blades, having one blade of said set disposed on one side of said track and the other blade of said set disposed on the opposite side of said track;
a second set of two saw blades, laterally displaced from said first set of blades along said track, having one blade of said set disposed on one side of said track and the other blade of said set disposed on the opposite side of said track;
wherein said first set of blades cuts opposing sides of said CRT and said second set of blades cuts the uncut opposing sides of said CRT.

19. The apparatus of claim 18 wherein said actuator can rotate said CRT 90 degrees between said first and said second set of saw blades.

20. An apparatus for bisecting a CRT having a panel portion, a funnel portion and a frit line connecting said panel and funnel portions, comprising:
a track;
an actuator, for holding said CRT during said bisecting process; said actuator being capable of moving along said track;
a first set of two saw blades, having one blade of said set disposed on one side of said track and the other blade of said set disposed on the opposite side of said track;
a second set of two saw blades, laterally displaced from said first set of blades along said track, having one blade of said set disposed on one side of said track and the other blade of said set disposed on the opposite side of said track;
a third set of two saw blades, laterally displaced from said second set of blades along said track, having one blade of said set disposed on one side of said track and the other blade of said set disposed on the opposite side of said track; and
a fourth set of two saw blades, laterally displaced from said third set of blades along said track, having one blade of said set disposed on one side of said track and the other blade of said set disposed on the opposite side of said track;
wherein said first set of blades cuts approximately one half of the depth of the glass and said second set of blades cuts the remaining depth of the glass on opposing sides of said CRT; and
wherein said third set of blades cuts approximately one half of the depth of the glass and said fourth set of blades cuts the remaining depth of the glass on the uncut opposing sides of said CRT.

21. The apparatus of claim 20 wherein said actuator can rotate said CRT by 90 degrees between said second and said third set of saw blades.
